(19) United States
(12) Patent Application Publication
(10) Pub. No.: US 2009/0162183 A1
(43) Pub. Date: Jun. 25, 2009

(54) FULL-CONTACT RING FOR A LARGE WAFER

(76) Inventor: Peter Davison, Puyallup, WA (US)

Correspondence Address: INTEL CORPORATION;c/o CPA Global, P.O. BOX 52050, MINNEAPOLIS, MN, 55402, US

(21) Appl. No.: 11/960,214

(22) Filed: Dec. 19, 2007

(51) Int. Cl. B65G 59/00; B24B 29/02; B65D 85/00

(52) U.S. Cl. 414/798.9; 118/728; 206/711

(57) ABSTRACT

The present invention describes a method including: opening a door of a shell, the shell enclosing a stack of full-contact rings; determining a full-contact ring within the stack to engage; opening split ends of the full-contact ring to release a large wafer; lowering the large wafer from the full-contact ring; closing the split ends of the full-contact ring; extracting the large wafer from the shell; and closing the door of the shell.

### BACKGROUND OF THE INVENTION

1. Field of the Invention

The present invention relates to a field of semiconductor integrated circuit manufacturing, and more specifically, to a method of supporting a large wafer during transport and manufacturing.

2. Discussion of Related Art

Gordon Moore originally observed in 1964 that technology innovation results in a doubling of the number of transistors per unit area on an integrated circuit (IC) chip every 12 months. By 1975, the trend had settled down to a doubling about every 18 months. Over the ensuing decades, the semiconductor industry has adhered closely to Moore's Law in increasing the density of transistors for each generation of IC chips.

Maintaining such a schedule has required a scaling down of the metal oxide semiconductor field effect transistor (MOSFET) that is used in a complementary metal-oxide-semiconductor (CMOS) circuit. The characteristics of the transistor have been improved by implementing various advanced features such as twin well, super-steep retrograde well profile, abrupt source and drain (S/D) junction, highly doped channel, thinner gate dielectric, and shorter gate length.

The IC chip includes a planar transistor that is formed in a bulk substrate, such as a wafer. The wafer is made from a semiconductor, such as silicon. During processing, a material may be added to, or removed from, the wafer. The material may include an insulator, such as silicon oxide, or a conductor, such as copper.

Some processes that may be used to add the material, partially or completely, to the wafer include chemical vapor deposition, sputtering, electroplating, oxidation, and ion implantation. Other processes that may be used to remove the material, partially or completely, from the wafer include wet etching, dry etching, and chemical-mechanical polishing. As needed, photolithography may be used to restrict the process to a certain portion of the wafer.

Many parameters of the IC chip are monitored during fabrication to ensure that the product specification for performance and reliability will be met even as the design rule becomes tighter. However, as the wafer size becomes larger, such as a diameter of 450 mm, challenges may arise in handling and transporting the wafer without incurring any damage.

### BRIEF DESCRIPTION OF THE DRAWINGS

FIG. 1 is a plan view of a full-contact ring in a close configuration stacked inside a shell according to an embodiment of the present invention.

FIG. 2 is a plan view of a full-contact ring in an open configuration according to an embodiment of the present invention.

### DETAILED DESCRIPTION OF THE PRESENT INVENTION

In the following description, numerous details, such as specific materials, dimensions, and processes, are set forth in order to provide a thorough understanding of the present invention. However, one skilled in the art will realize that the invention may be practiced without these particular details. In other instances, well-known semiconductor equipment and processes have not been described in particular detail so as to avoid obscuring the present invention.

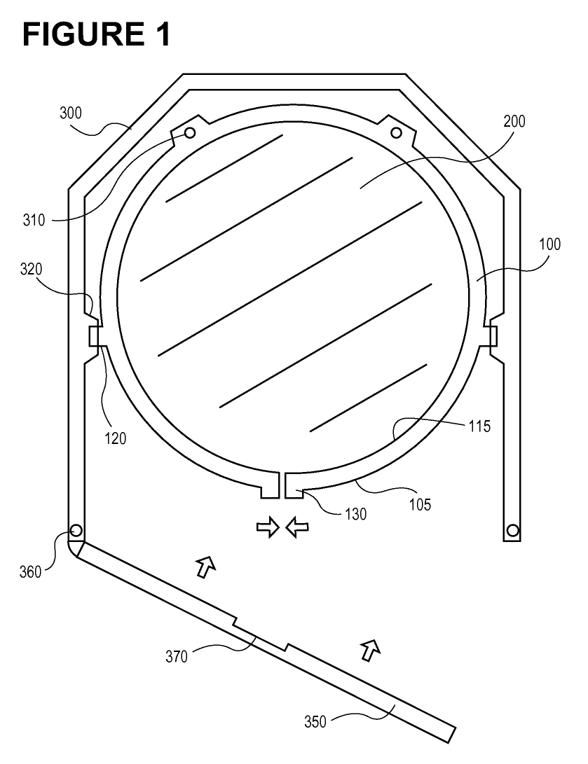

In an embodiment of the present invention as shown in FIG. 1, a full-contact ring 100 secures, holds, or supports a substrate, such as a large wafer 200. The large wafer 200 may include an elemental semiconductor, such as silicon, or a compound semiconductor, such as silicon germanium (SiGe) or gallium arsenide (GaAs).

The full-contact ring 100 prevents the large wafer 200 from accumulating damage during manufacture of an Integrated Circuit (IC) chip. The damage may be structural, mechanical, physical, or chemical. The damage may be localized to a portion of an edge, surface, or bulk of the large wafer 200.

In particular, the full-contact ring 100 prevents the large wafer 200 from sustaining damage when stored, transported, or handled between process steps. Damage to the large wafer 200 may result from improper or excessive exposure, contact, shock, or vibration.

The large wafer 200 may be circular. In an embodiment of the present invention, the large wafer 200 has a diameter of 150 millimeters (mm). In an embodiment of the present invention, the large wafer 200 has a diameter of 200 mm. In an embodiment of the present invention, the large wafer 200 has a diameter of 300 mm. In an embodiment of the present invention, the large wafer 200 has a diameter of 450 mm. In an embodiment of the present invention, the large wafer 200 has a diameter of 675 mm.

The large wafer 200 may be circular and flat. In an embodiment of the present invention, the large wafer 200 has a diameter of 150 (±0.2) mm and a thickness of 675 (±15) microns (um). In an embodiment of the present invention, the large wafer 200 has a diameter of 200 (±0.2) mm and a thickness of 725 (±15) microns (um). In an embodiment of the present invention, the large wafer 200 has a diameter of 300 (±0.2) mm and a thickness of 775 (±25) um. In an embodiment of the present invention, the large wafer 200 has a diameter of 450 mm and a thickness selected from a range of 700-1,300 um. In an embodiment of the present invention, the large wafer 200 has a diameter of 450 mm and a thickness selected from a range of 825-925 um. In some situations, the large wafer 200 is thicker than otherwise required so as to accommodate strips, cleans, etches, and reworks.

In an embodiment of the present invention as shown in FIG. 1, multiple full-contact rings 100 are nested within a shell 300 for an in-fab wafer carrier or a wafer shipper. In an embodiment of the present invention, the full-contact rings 100 are disassembled to clean the shell 300. In an embodiment of the present invention, the full-contact rings 100 are left in place even when cleaning the shell 300.

In an embodiment of the present invention, a maximum of 5 full-contact rings 100 are stacked inside the shell 300. In an embodiment of the present invention, a maximum of 10 full-contact rings 100 are stacked inside the shell 300. In an embodiment of the present invention, a maximum of 15 full-contact rings 100 are stacked inside the shell 300. In an embodiment of the present invention, a maximum of 20 full-contact rings 100 are stacked inside the shell 300. In an embodiment of the present invention, a maximum of 25 full-contact rings 100 are stacked inside the shell 300.

The shell 300 is a housing that provides support and protection for the large wafers 200 held by the full-contact rings 100. In an embodiment of the present invention, the shell 300 keeps dust out, allows purging, and protects the large wafer 200 from damage.

In an embodiment of the present invention, the shell 300 has a width of 539.5 mm and a depth of 505 mm. In an embodiment of the present invention as shown in FIG. 1, the shell 300 has corners that are faceted to reduce volume that needs to be purged. In an embodiment of the present invention as shown in FIG. 1, the shell 300 has corners that are rounded to reduce stress that may result from the weight of the large wafers 200.

In an embodiment of the present invention, the shell 300 has an outer wall with a thickness of 2.0-3.0 mm. In an embodiment of the present invention, the shell 300 has an outer wall with a thickness of 3.0-4.0 mm.

The shell 300 has an opening in the front wall. In an embodiment of the present invention, the opening occupies most of the front wall. In an embodiment of the present invention, the center of the front wall of the shell 300 is located at a 6 o'clock position.

In an embodiment of the present invention, the portion of the shell 300 surrounding the opening is reinforced by stiffener rods 360 placed near the edges of the opening. In an embodiment of the present invention, the portion of the shell 300 surrounding the opening is reinforced by a stiffener hoop, such as is formed by connecting some, or all, of the stiffener rods 360.

In an embodiment of the present invention, the opening of the shell 300 has a recloseable door 350 with a latch. In an embodiment of the present invention, the opening of the shell 300 has a resealable door 350 with a hinge. The door 350 of the shell 300 is dedicated to barrier protection and is decoupled from retention of the large wafer 200. A key is not used to lock the door 350 of the shell 300.

In an embodiment of the present invention, one or more full-contact rings 100 are evenly arranged inside the shell 300. In an embodiment of the present invention, the full-contact rings 100 are separated by integrated flanges. In an embodiment of the present invention, the full-contact rings 100 are separated by discrete collars.

In an embodiment of the present invention, a vertical stack of full-contact rings 100 is aligned and supported by pillars 310 which are connected to a top flange and a base of the shell 300. The shell 300 is not used as a primary structural support so dimensional variation is minimized. Instead, as load-bearing members, the pillars 310 transfer weight and stress from the full-contact rings 100 and the enclosed large wafers 200 to external handling interfaces that are located above and below the shell 300.

In an embodiment of the present invention, the pillars 310 include rigid structural support bars, such as two long shoulder bolts, that secure the vertical stack of full-contact rings 100 inside the shell 300. In an embodiment of the present invention, support is provided at two locations towards the rear of the full-ring contact 100, such as at 11 o'clock and at 1 o'clock.

In an embodiment of the present invention, the full-contact ring 100 is further supported by tabs or outriggers 120. In an embodiment of the present invention, support is provided at two locations towards the sides of the full-contact ring 100, such as at 8 o'clock and at 4 o'clock. In an embodiment of the present invention, the outriggers 120 of a stack of full-contact rings 100 are supported by ribs 320 inside the shell 300. In an embodiment of the present invention, the outriggers 120 of a stack of full-contact rings 100 are supported by a shelf that runs along part or all of the left and right sides of the inside of the shell 300.

In an embodiment of the present invention, the full-contact ring 100 has no rubbing or sliding parts near the large wafer 200, such as in a hinge, so as to avoid forming, accumulating, spreading, or transferring particulates or contaminants.

In an embodiment of the present invention, the full-contact ring 100 includes two arms 105 that are connected. Each arm 105 of the full-contact ring 100 has a semicircular or “C” shape. Each arm 105 of the full-contact ring 100 has an inner groove 115 and an outer circumference 105. The two arms 105 curve around the sides and approach each other towards the front until the split ends 130 are separated by an adjustable gap.

When the full-contact ring 100 is in a close configuration, the split ends 130 of the two arms 105 are brought into close proximity with a small gap as shown in FIG. 1. In an embodiment of the present invention, the split ends 130 are engaged. In an embodiment of the present invention, the split ends 130 are interlocked. In an embodiment of the present invention, the split ends 130 of the two arms 105 are aligned but not locked when the full-contact ring 100 is in a closed position.

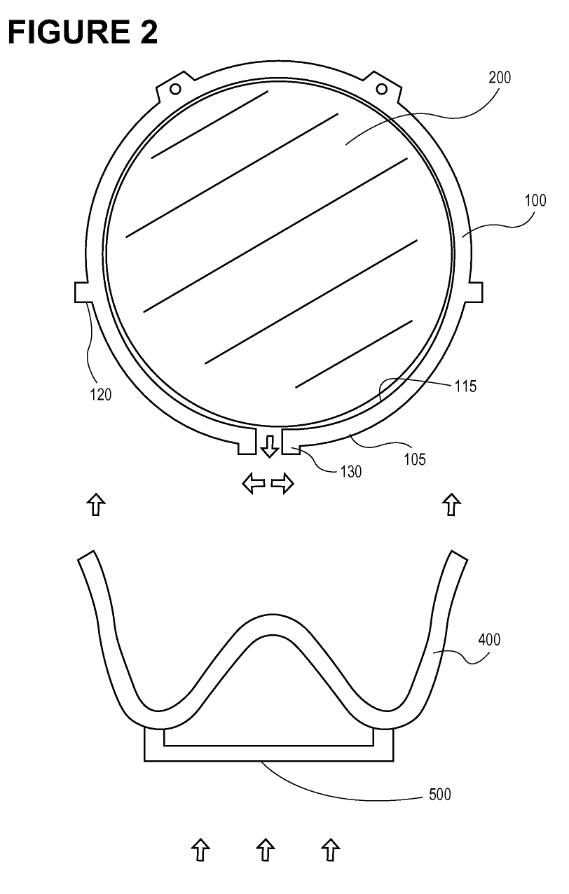

When the full-contact ring 100 is in an open configuration, the split ends 130 of the two arms 105 are separated with a large gap as shown in FIG. 2. In an embodiment of the present invention, the split ends 130 are disengaged. In an embodiment of the present invention, the split ends 130 are unlocked.

In an embodiment of the present invention, the full-contact ring 100 is further captured and supported towards the front of the shell 300 by pins or a recess 370 located in the door 350 of the shell 300.

In an embodiment of the present invention, the full-contact ring 100 has a flatness of 0.1-0.3 mm. In an embodiment of the present invention, the full-contact ring 100 has a flatness of 0.3-0.7 mm. In an embodiment of the present invention, the full-contact ring 100 has a flatness of 0.7-1.3 mm.

In an embodiment of the present invention, each arm 105 has a (vertical) height of 10-20 mm to minimize sag of the large wafer 200 that is being supported or held. In an embodiment of the present invention, the height of each arm 105 is in a direction perpendicular to a surface of the large wafer 200.

In an embodiment of the present invention, each arm 105 has a (lateral) thickness of 1.5 mm to maximize flexibility. In an embodiment of the present invention, the thickness of each arm 105 is in a direction parallel to a surface of the large wafer 200.

In an embodiment of the present invention, each arm 105 of the full-contact ring 100 includes an inner groove 115. In an embodiment of the present invention, the groove 115 has parallel edges that are chamfered. In an embodiment of the present invention, the groove 115 has a cross-section with a variable radius of curvature that is larger towards an open exterior end of the groove 115 and smaller towards a close interior end of the groove 115. In an embodiment of the present invention, the wall of the cross-section of the groove 115 varies as continuous curves. In an embodiment of the present invention, the radius of curvature of the cross-section of the groove 115 varies as discrete steps.

A first consequence of having a groove with the chamfered cross-section is that the outer edges of the large wafer 200 can move towards the close interior end of the groove 115 more readily when the full contact ring 100 is in the open configuration as shown in FIG. 2. The groove 115 can capture, align, and center the large wafer 200 even when the large wafer 200 is not entirely flat or is slightly off-center.

A second consequence of having the groove 115 with the chamfered cross-section is that the outer edges of the large wafer 200 can fit against the interior walls of the groove 115 more securely when the full contact ring 100 is in the close configuration as shown in FIG. 1.

In an embodiment of the present invention, the interior wall of the groove 115 touches the upper surface of the large wafer 200 in an approximately parallel way in an area within a distance of 1.5 mm inwards from the edge.

In an embodiment of the present invention, the interior wall of the groove 115 touches the upper surface of the large wafer 200 in an approximately tangential way in a location within a distance of 1.5 mm inwards from the edge.

In an embodiment of the present invention, the entire periphery of the large wafer 200 is supported or held. Consequently, the full-contact ring 100 uniformly distributes the weight of the large wafer 200 and prevents significant movement of the large wafer 200.

In an embodiment of the present invention, the full-contact ring 100 minimizes wafer sag.

In an embodiment of the present invention, the full-contact ring 100 minimizes wafer displacement.

In an embodiment of the present invention, the full-contact ring 100 minimizes wafer rotation.

In an embodiment of the present invention, the full-contact ring 100 minimizes wafer stress.

In an embodiment of the present invention, two adjacent full-contact rings 100 minimize wafer-to-wafer contact. In an embodiment of the present invention, the full-contact ring 100 maintains 10-12 mm-wafer pitch spacing. In an embodiment of the present invention, the full-contact ring 100 maintains 12-14 mm-wafer pitch spacing.

In an embodiment of the present invention, the full-contact ring 100 is actuated by a flexure 400. The flexure 400 engages the full-contact ring 100 to separate the split ends 130. The two arms 105 of the full-contact ring 100 may be spread apart to a larger circumference, thus enlarging the gap between the split ends 130, until the large wafer 200 has sufficient clearance to be moved inside or outside the full-contact ring 100.

In an embodiment of the present invention, the nominal radius of an imaginary circle inscribed by the full-contact ring 100 is increased by 1.5-3.0 mm per side to allow the large wafer 200 to be moved inside or outside. In an embodiment of the present invention, the nominal radius of an imaginary circle inscribed by the full-contact ring 100 is increased by 3.0-4.5 mm per side to allow the large wafer 200 to be moved inside or outside.

The large wafer 200 is loaded or unloaded into the chamfered groove 115 of the full-contact ring 100 from below (the bottom side). A robotic mechanism 500, such as a 6-axis robotic mechanism, may be used for handling the large wafer 200. Given a vertical pitch of 10 mm between adjacent full-contact rings 100 in a stack, the extraction volume includes a width of 450 mm, a height of 7.9 mm in the middle portion, and a height of 3.381 mm on both left side and right side. In an embodiment of the present invention, the large wafer 200 advances 3 mm outward (towards the door or the front), then drops downwards 3 mm, before exiting the shell 300.

In an embodiment of the present invention, the full-contact ring 100 is formed from a flexible material. The flexible material allows the full-contact ring 100 to be bent repeatedly or deformed continually.

In an embodiment of the present invention, the full-contact ring 100 is formed from a tough material. The tough material allows the full-contact ring 100 to be restored or returned to its original size and shape without sustaining damage.

In an embodiment of the present invention, the full-contact ring 100 is formed from a compliant material. The compliant material allows the full-contact ring 100 to remain in contact with the large wafer 200 that is being supported or held.

Injection molding of a structural part having thin walls requires a resin that has a good balance of temperature resistance, mechanical properties, and chemical resistance.

In an embodiment of the present invention, the full-contact ring 100 is formed from a clean polyetheretherketone polymer (available as VICTREX® PEEK™ from Victrex plc, Lancashire, UK, having a melt viscosity grade of 90G or 150G) that is impregnated or filled with milled Carbon fiber (MCF) for electrostatic discharge (ESD) protection.

The PEEK material is a semicrystalline thermoplastic polymer compound that demonstrates high temperature resistance (continuous use at a temperature up to 260 degrees Centigrade), exceptional strength and hardness (flexural modulus, as tested at 23 degrees Centigrade, in a range from 4.1 GigaPascals when unfilled to 20.2 GPa when filled), and outstanding chemical resistance (inert to water, pressurized steam, and almost all chemicals except halogen gases, some strong acids, and a few sulfur compounds), and low particle shedding. However, the PEEK material has a high cost.

In an embodiment of the present invention, the full-contact ring 100 is formed from a clean liquid crystal polymer (LCP) impregnated or filled with milled Carbon fiber (MCF). The LCP material is a class of wholly aromatic polyester polymers that provides excellent wear resistance, low particle shedding, and low moisture absorption at an intermediate cost. The LCP material offers excellent barrier performance for purge applications and is self-extinguishing.

In an embodiment of the present invention, the full-contact ring 100 is formed from Polyetherimide (PEI). The PEI material is a thermoplastic polymer that provides good performance at a moderate cost. The PEI material is available as Ultem® from Sabic Innovative Plastics, Pittsfield, Mass. (formerly part of General Electric, Fairfield, Conn.).

In an embodiment of the present invention, the primary shell 300 and door 350 for an in-fab wafer carrier are formed from the LCP material.

In an embodiment of the present invention, the primary shell 300 and door 350 for a wafer shipper are formed from a low ionic grade polycarbonate (PC). The PC material provides a minimum or adequate performance at a low cost. Unfilled PC may be used for shipping containers since ESD protection may not be necessary.

Many embodiments and numerous details have been set forth above in order to provide a thorough understanding of the present invention. One skilled in the art will appreciate that many of the features in one embodiment are equally applicable to other embodiments. One skilled in the art will also appreciate the ability to make various equivalent substitutions for those specific materials, processes, dimensions, concentrations, etc. described herein. It is to be understood that the detailed description of the present invention should be taken as illustrative and not limiting, wherein the scope of the present invention should be determined by the claims that follow.

We claim:

1. A method comprising:
opening a door of a shell, said shell enclosing a stack of full-contact rings;
determining a full-contact ring within said stack to engage;
opening split ends of said full-contact ring to release a large wafer;
lowering said large wafer from said full-contact ring;
closing said split ends of said full-contact ring;
extracting said large wafer from said shell; and
closing said door of said shell.

2. The method of claim 1 wherein said split ends are interlocked until opening.

3. The method of claim 1 comprising lowering said large wafer a distance of 3 mm when said stack of full-contact rings has a pitch of 10-12 mm.

4. The method of claim 1 wherein said large wafer is released from an internal groove in said full-contact ring.

5. A full-contact ring to hold a large wafer comprising:
two arms, said arms being semicircular, said arms having split ends located at 6 o'clock;
two pillars securing said arms, said pillars being rigid, said pillars located at 11 o'clock and 1 o'clock; and
two outriggers supporting said arms, said outriggers being at 8 o'clock and 4 o'clock.

6. The full-contact ring of claim 5 wherein said arms are formed from a polyetheretherketone (PEEK) material filled with milled Carbon fiber (MCF).

7. The full-contact ring of claim 5 wherein said arms are formed from a liquid crystal polymer (LCP) material filled with milled Carbon fiber (MCF).

8. The full-contact ring of claim 5 wherein said arms include an internal groove to hold said large wafer.

9. The full-contact ring of claim 5 wherein said split ends may be interlocked.

10. A shell comprising:
a vertical stack of full-contact rings;
pillars to support said full-contact rings;
ribs to support outriggers on said full-contact rings; and
a door.

11. The shell of claim 10 comprising a liquid crystal polymer (LCP) material filled with milled Carbon fiber (MCF) for an in-fab wafer carrier.

12. The shell of claim 10 further comprising a large wafer held by each of said full-contact rings.

13. The shell of claim 10 comprising a Liquid Crystal Polymer (LCP).

14. The shell of claim 10 comprising a polycarbonate material for a wafer shipper.
